(19) United States
(12) Patent Application Publication
(10) Pub. No.: US 2008/0285402 A1
(43) Pub. Date: Nov. 20, 2008

(54) OPTICAL DISC APPARATUS AND OPTICAL DISC RECORDING AND REPRODUCING METHOD

(75) Inventors: Takahiko Mihara, Kawasaki-shi (JP); Tatsuji Ashitani, Yokohama-shi (JP); Yuichi Ito, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/121,738

(22) Filed: May 15, 2008

(30) Foreign Application Priority Data
May 15, 2007 (JP) 2007-129441

(51) Int. Cl. G11B 20/10

(52) U.S. Cl. 369/47.5

(57) ABSTRACT

According to one embodiment, there is provided an optical disc apparatus including: a recording unit forming a mark and a space on the optical disc by using a laser beam having a set recording power level and, thus, recording data on an optical disc; a reproduction unit reproducing the mark and the space formed on the optical disc; a change amount calculating unit calculating an amount of change in an amplitude of readout signal for the space reproduced by the reproduction unit; and a recording power determining unit determining an optimal recording power level of the laser beam so as to set the calculated amount of change in the amplitude of the readout signal within a predetermined range.

### CROSS-REFERENCE TO RELATED APPLICATIONS

This application is based upon and claims the benefit of priority from Japanese Patent Application No. 2007-129441, filed on May 15, 2007, the entire contents of which are incorporated herein by reference.

### BACKGROUND

1. Field

One embodiment of the invention relates to an optical disc apparatus and an optical disc recording and reproducing method, and more particularly, to an optical disc apparatus and an optical disc recording and reproducing method which record/reproduce data on rewritable optical discs.

2. Description of the Related Art

As rewritable optical discs, there are DVD-RWs, DVD-RAMs, HD DVD-RWs, and HD DVD-RAMs, as examples. It is known that the quality of recording signals recorded on these rewritable optical discs depends on recording parameters such as a laser power level for recording and a waveform of a recording signal. Accordingly, a general process in which a test period is provided at a time after insertion of an optical disc into an optical disc apparatus or the like and optimal recording parameters are acquired during the test period is performed.

In order to select evaluation indexes for acquiring the optimal recording parameters, there have been proposed various evaluation indexes for the recording parameters. It is disclosed by, for example, No. 2005-158245 that the optimal recording parameters are acquired by a PRML error index called “M” as the evaluation index.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing a structure of an optical disc apparatus according to an embodiment of the present invention.

FIGS. 2(a), 2(b) are exemplary diagrams showing a relationship between recording power levels of recording waveforms and a mark and a space of an optical disc.

FIGS. 3(a), 3(b) are exemplary diagrams showing a recording pattern in embodiments.

FIG. 4 is an exemplary diagram showing changes in variations of crest values of a space area depending on an erase power level.

FIG. 5 is an exemplary flowchart showing a process of recording power control method according to a first embodiment of the invention.

FIG. 6 is an exemplary diagram showing a method of changing peak power and erase power levels.

FIG. 7 is an exemplary diagram showing a sampling position of a readout signal.

FIGS. 8(a), 8(b) are exemplary diagrams showing changes of a standard deviation and an average value of erase power levels.

FIGS. 9(a)-9(d) are exemplary diagrams showing appropriate ranges of erase and peak power levels for each times of evaluation overwriting operation.

FIGS. 10(a), 10(b) are exemplary diagram showing dependence of a PRSNR on erase and peak power levels.

FIG. 11 is an exemplary flowchart showing a process of recording power control method according to a second embodiment of the invention.

FIG. 12 is an exemplary diagram showing a relationship between a standard deviation of a crest value of a 11T space area and the erase power level.

### DETAILED DESCRIPTION

Various embodiments according to the invention will be described hereinafter with reference to the accompanying drawings. In general, according to one embodiment of the invention, there is provided an optical disc apparatus including: a recording unit forming a mark and a space on the optical disc by using a laser beam having a set recording power level and, thus, recording data on an optical disc; a reproduction unit reproducing the mark and the space formed on the optical disc; a change amount calculating unit calculating an amount of change in an amplitude of readout signal for the space reproduced by the reproduction unit; and a recording power determining unit determining an optimal recording power level of the laser beam so as to set the calculated amount of change in the amplitude of the readout signal within a predetermined range.

On rewritable optical discs, a new series of marks and spaces is overwritten to a recorded series of marks and spaces. This overwriting operation is called “overwriting”.

In order to overwrite a mark, for example, a laser pulse train having a plurality of sub-pulses having two power levels called a peak power level and a bottom power level is irradiated from above the formed mark or space, whereby a new mark having a predetermined length is formed.

In addition, in order to overwrite a space, for example, a laser beam having a power level called an erase power level is irradiated from above the formed mark or space, whereby a new space having a predetermined length is formed.

The amplitude of readout signals acquired from the overwritten mark or space may have constant values corresponding thereto when the overwritten mark or space is reproduced. The reason is that data other than the recorded data may be reproduced when the amplitude of the readout signal changes markedly.

However, especially when the space is overwritten (including when the space is formed for the first time), it has been found by the inventors of the present invention that the amplitude of readout signals of the spaces vary without being maintained to a constant value depending on an erase power level used for forming the space. While the variance of the amplitude of the readout signals of the formed spaces increases when the erase power level for overwriting the space is too low, the variance of the amplitude of the readout signals of the formed spaces increases when the erase power level is too high. In other words, in order to make the variance of the amplitude of the readout signals of the spaces within an allowable range, the erase power level is set in an optimal range.

It is found that the optimal range of the erase power level depends not only on characteristics of optical discs but also on the peak power level or the number of times of overwriting. Accordingly, these factors are considered for determining the optimal range of the erase power levels.

Hereinafter, structure and overall Operation of Optical Disc Apparatus are exemplary described.

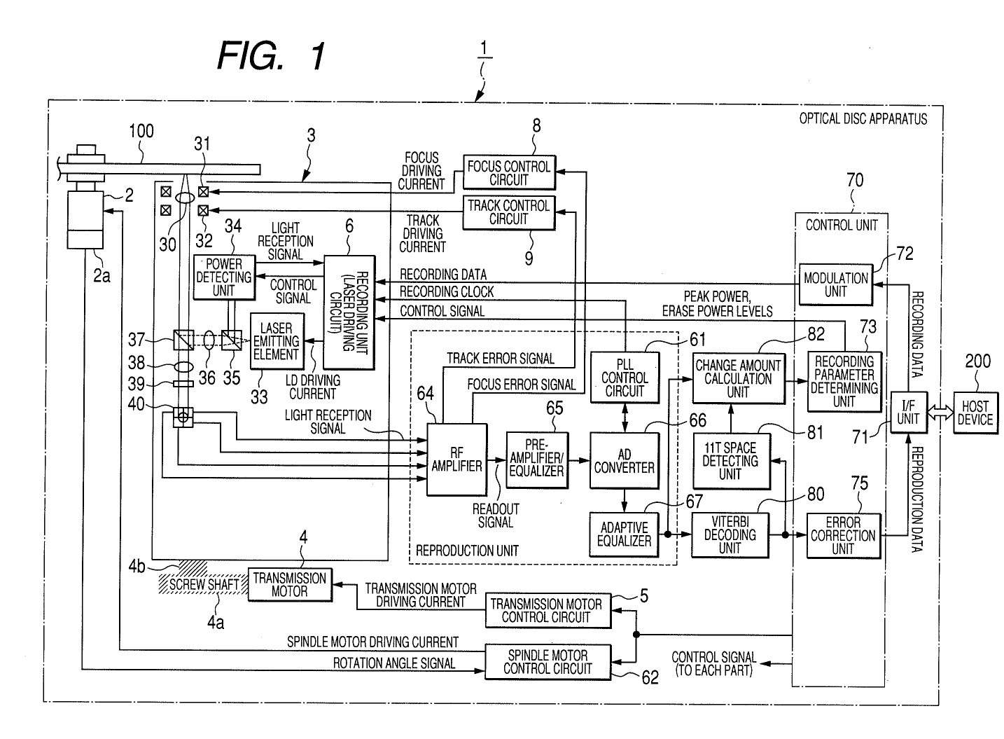

FIG. 1 is a diagram showing a structure of an optical disc apparatus 1 according to an embodiment of the invention.

The optical disc apparatus 1 records and reproduces information on a rewritable optical disc 100 such as a DVD-RW, a DVD-RAM, an HD DVD-RW, or an HD DVD-PAM. On the optical disc 100, there is a spiral guide way. Concave portions of the guide way are called grooves and convex portions of the guide way are called lands, and one circle of each one of the grooves or the lands is called a track. User's data is recorded on the optical disc by an irradiating intensity-modulated laser beam along the track (the groove only or both the groove and the land) so as to form marks and spaces corresponding to the code length of the data.

The data is reproduced by irradiating a laser beam having a power level (read power level) for reading, which is lower than that for recording, along the track and detecting changes in the intensity of light reflected from the marks and the spaces on the track. The recorded data is erased by irradiating a laser beam having a power level (erase power level) for erasing, which is higher than that for reading, along the track and performing a crystallization process for a recording layer.

The optical disc 100 is driven for rotation by a spindle motor 2. A rotation angle signal is supplied from a rotary encoder 2a that is provided in the spindle motor 2. As the rotation angle signal, for example, five pluses are generated for each rotation of the spindle motor 2. The rotation angle and number of rotations of the spindle motor 2 can be determined from the rotation angle signal, and thus a spindle motor control circuit 62 controls the rotation of the spindle motor 2 on the basis of the information on the rotation angle and number of rotations of the spindle motor 2.

The recording and reproduction of the optical disc 100 is performed by an optical pickup 3. The optical pickup 3 is connected to a transmission motor 4 through a gear 4b and a screw shaft 4a, and the transmission motor 4 is controlled by a transmission motor control circuit 5. The transmission motor 4 is rotated by a transmission motor driving current sent from the transmission motor control circuit 5, and thereby the optical pickup 3 moves in a radial direction of the optical disc 100.

An objective lens 30 that is supported by a wire or a plate spring (not shown) is provided in the optical pickup 3. The objective lens 30 can be moved in a focusing direction (optical axial direction of the objective lens) by driving a driving coil 31. In addition, the objective lens 30 can be moved in a tracking direction (a direction perpendicular to the optical axis of the objective lens) by driving a driving coil 32.

A laser driving circuit (recording unit) 6, supplies a driving current for writing to a laser diode (laser emitting element) 33 on the basis of recording data modulated by a modulation unit 72 using an ETM (Eight to Twelve Modulation) method or the like. To the modulation unit 72, the recording data is supplied from a host device 200 such as a personal computer through an I/F unit 71.

The laser driving circuit 6 supplies a driving current for reading, which is smaller than the current for writing, to the laser diode 33 when the information is to be read.

A power detecting unit 34 (referred to as a front monitor (FM) in some cases) that is configured by a photo diode and the like divides a predetermined ratio of the laser beam generated by the laser emitting element 33 by using a half mirror 35 and detects a signal in proportion to a light intensity, that is, a power level of light emission as a light reception signal. The detected light reception signal is supplied to the laser driving circuit 6. The laser driving circuit 6 controls the laser emitting element 33 on the basis of the light reception signal sent from the power detecting unit 34 so as to emit light at a recording power level, a recording pulse width, a power level for reproduction, and a power level for erasing that are determined to be set by a recording parameter determining unit 73 of the control unit 70 or the like.

The laser emitting element 33 generates a laser beam on the basis of the driving current supplied from the laser driving circuit 6. The laser beam generated from the laser emitting element 33 is irradiated on the optical disc 100 through a collimator lens 36, a half prism 37, and the objective lens 30.

On the other hand, light reflected from the optical disc 100 is guided to a light detector 40 through the objective lens 30, the half prism 37, a condensing lens 38, and a cylindrical lens 39.

The light detector 40, for example, has a four-divided light detecting cell, and detection signals from the light detecting cell is output to an RF amplifier 64 of a reproduction unit 60. The RF amplifier 64 processes the signals from the light detecting cell and generates a focus error signal FE indicating an error deviated from a just focus position, a tracking error signal TE indicating en error between the center of a beam spot of the laser beam and the center of a track, and a readout signal that is a signal generated by the sum of the signals from the light detecting cell.

The focus error signal FE is supplied to a focus control circuit 8. The focus control circuit 8 generates a focus driving signal in accordance with the focus error signal FE. The focus driving signal is supplied to the driving coil 31 for the movement in the focusing direction. Thereby, a focus servo control operation by which the laser beam is continuously located in just focus positions on a recording film of the optical disc 100 is performed.

The tracking error signal TE is supplied to a track control circuit 9. The track control circuit 9 generates a track driving signal in accordance with the tracking error signal TE. The driving signal output from the track control circuit 9 is supplied to the driving coil 32 for the movement in the tracking direction. Thereby, a tracking servo control operation by which the laser beam continues to trace a track formed on the optical disc 100 is performed.

By the above-described servo control and tracking servo operations, the focus of the laser beam can trace the tracks on a recording surface of the optical disc with a high precision. As a result, changes in a beam reflected from the marks or the spaces which are formed on the tracks of the optical disc 100 in accordance with recording information are correctly reflected to the sum signal RF of the output signals of light detecting cells of the light detector 40, whereby it is possible to acquire readout signals having excellent quality.

This production signal (the sum signal RF) is input to a pre-amplifier/equalizer 65. The production signal is amplified to have an appropriate amplitude by the pre-amplifier/equalizer 65, and then an operation for shaping the waveform thereof is performed. The output of the pre-amplifier/equalizer 65 is sampled by an AD converter 66 in accordance with reproduction clock signals sent from a PLL control circuit 61 and is converted into multi-valued digital data.

The digital reproduction signal is input to an adaptive equalizer 67, and a waveform equalization process in accordance with a predetermined partial response type (class) is performed for the input signal. The adaptive equalizer 67, for example, has an adaptive transversal filter. The waveform equalization process is performed by adapting a weighting factor such that an error between reference data that is generated so as to have an ideal partial response for decoding data decoded by a Viterbi decoding unit 80 in the latter stage and input data becomes zero.

An equalized readout signal that is an output of the adaptive equalizer 67 is input to the Viterbi decoding unit 80. The Viterbi decoding unit 80 decodes the input equalized readout signal series into the recording data by a Viterbi decoding process using a maximum likelihood estimation method for acquiring decoding data.

The decoding data is input to an error correction unit 75. An error correction process is performed for the decoding data by the error correction unit 75, and the corrected decoding data is output to the host device 200 through an I/F unit 71.

In addition, the decoding data is input to an 11T space detecting unit 81. The 11T space detecting unit 81 detects a space of a predetermined code length, for example, an 11T space that has the longest code length from the decoding data and outputs appearing timing of the 11T space to a change amount calculating unit 82.

To the change amount calculating unit 82, an equalized readout signal that is an output signal of the adaptive equalizer 67 and the appearing timing of the 11T space are input. The change amount calculating unit 82 extracts crest values of the 11T spaces from streams of the equalized readout signal on the basis of the appearing timing of the 11T spaces and temporarily stores a predetermined amount of the crest values. Then, the change amount calculating unit 82 calculates statistics of the crest values of the 11T spaces. For example, a standard deviation as the variance amount of the crest values of the 11T spaces or an average value is calculated.

During a test period, the recording power determining unit 73 sets recording power levels such as a plurality of peak power levels and a plurality of erase power levels in a recording unit 6 while sequentially changing the recording power levels. Then, the recording power determining unit 73 determines an optimal peak power level or an optimal erase power level on the basis of an evaluation value (in this embodiment, a standard deviation or an average value of the crest values of the 11T space) acquired at the recording power levels. Since the standard deviation or average value of the crest values of the 11T spaces also depends on the number of times of overwriting, the recording power determining unit 73 determines the optimal peak power level or the optimal erase power level with the number of times of overwriting operations performed during the test period considered.

When the test period elapses, the determined optimal peak power level or the optimal erase power level is set in the recording unit 6 so as to be used for recording of user data thereafter.

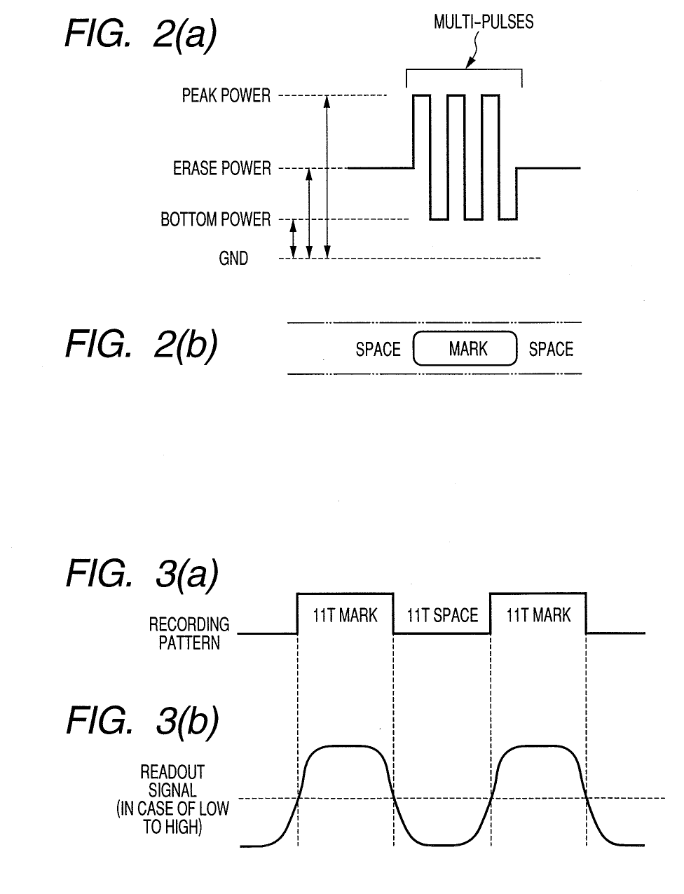

FIG. 2 is an exemplary schematic diagram showing a recording waveform generated on the basis of the recording parameter set in the recording unit 6 and the mark and space formed on a track of the optical disc 100 in accordance with the recording waveform. The recording on the optical disc 100 is performed by using change of a recording film due to increase of the temperature thereof which is caused by energy of a laser beam irradiated on the recording film. Accordingly, a form of the recording film may be deformed depending on heat distribution of the recording film. Thus, multi-pulses, as shown in FIG. 2(a), instead of a simple rectangular wave are used so as to control the heat distribution of the optical disc 100 with high precision.

In addition to division of a laser pulse (multi-pulse), various types of recording power levels are set for recording data on a phase-change recoding media such as HD DVD-RW. FIG. 2(a) shows three recording power levels of a peak power level, a bottom power level, and an erase power level, as an example. In this embodiment, the bottom bower level is regarded as 0 mW, and a term “recoding power” is used for collectively referring to the peak power and erase power levels.

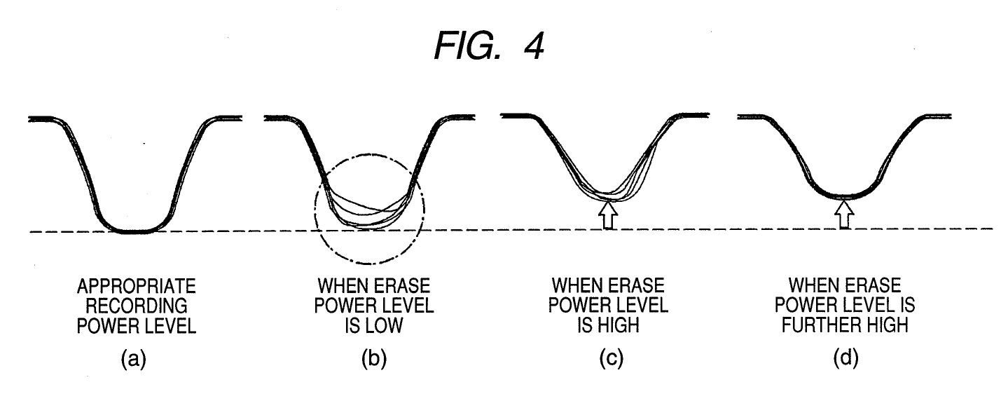

FIG. 3 shows a recording pattern that is used during the test period in the embodiment, as an example. In this embodiment, as described later, the optimal recording power level is determined by evaluating a standard deviation (variance amount) and an average value of crest values of a space area. Thus, it is preferable that the recording pattern has a long code for which the change of crest values of the space area can be easily detected. Accordingly, in this embodiment, a continuous recording pattern of 11T that is the longest code length of code lengths used for data recording is used as the recording pattern during the test period.

FIGS. 4(a), 4(b), 4(c), and 4(d) show change in the waveform of a readout signal of the space area which occurs when an inappropriate recording power level is used for overwriting.

FIG. 4(a) shows a readout signal when an overwriting operation is performed with an appropriate recording power level, and there is no change in the waveform of the readout signal. On the other hand, when an overwriting operation is performed with an inappropriate recording power level, there is change in the waveform of the readout signal as shown in FIGS. 4(b), 4(c), and 4(d).

FIG. 4(b) shows a readout signal in a case where the erase power level is lower than an appropriate level, and the crest value of a space area varies markedly. The reason for the variation of the crest value is assumed as follows. When a space is formed after being overwritten, there are cases where a mark in the previous recording is changed into a space and a case where a space formed in the previous recording is formed into a space.

In the former case, when the erase power level is lower than an appropriate level, the phase change from the mark into the space is not stable. On the other hand, in the latter case, the phase change is not used, and the level of the space is maintained. Accordingly, since the mark and space formed in the previous recording are randomly mixed in the area in which a space is to be formed by overwriting, it is assumed that random level change as shown in FIG. 4(b) occurs.

To the contrary to FIG. 4(b), when the erase power level is higher than the appropriate level, as shown in FIG. 4(c) or 4(d), the levels of the spaces increase on the average. It may be assumed that the phase change from the space to the mark due to increase in the erase power is started.

Since the erase power level depends on the peak power level, an optimal recording power level is selected from combinations of the erase and peak power levels for determining the optimal erase power at which a level variation of the space area is small and the average level of the space area is appropriate, in this embodiment.

Hereinafter, recording Power Control Method according to the first embodiment is exemplary described.

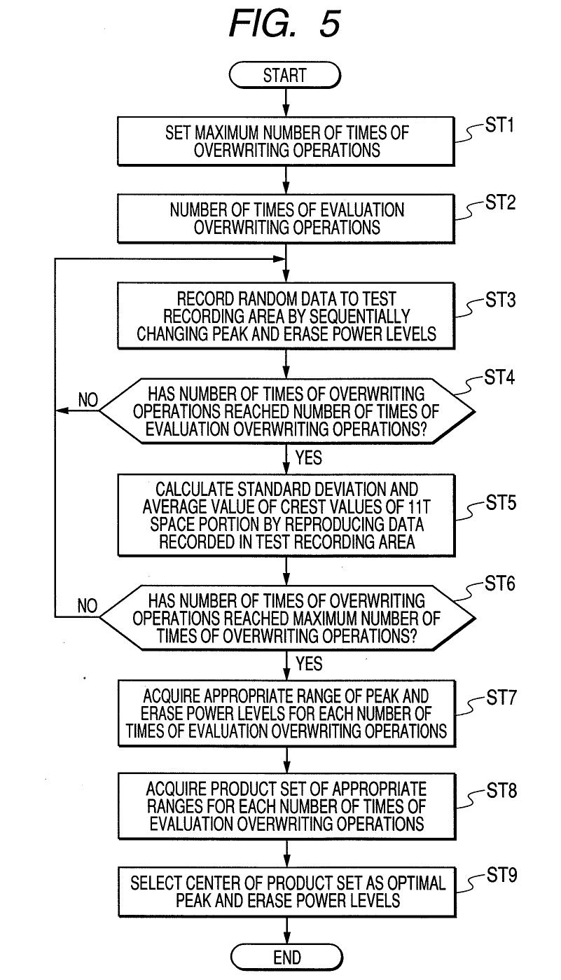

FIG. 5 is an exemplary flowchart of a process in a case where a recoding power control method (optical disc recording and reproducing method) is performed in the optical disc apparatus 1 according to the first embodiment.

At first, the maximum number of times of overwriting operations to be performed in the test recording and the number of times of evaluation overwriting operations indicating the number of times of overwriting operations is used for evaluation are set (steps ST1 and ST2). The number of times of the evaluation overwriting operations is for setting a plurality of evaluation points in the range of the maximum number of times of overwriting.

For example, the maximum number of times of overwriting is set to the 100th, and the number of times of the evaluation overwriting operations are set to 0-th (1st recording on a unused optical disc 100, and 0-th number of times of overwriting), 1st (2nd recording on the same area of the optical disc 100), 10th, and 100th. In this case, the number of evaluation points is four including evaluation points for the 1st recording, 1st overwriting, 10th overwriting and 100th overwriting.

Next, in step ST3, the peak and erase power levels are sequentially changed, and recording patterns are recorded in a test recording area (sometimes called PCA: Power Calibration Area) of the optical disc 100. In this case, the recording patterns, for example, are continuous patterns of 11T as shown in FIG. 3.

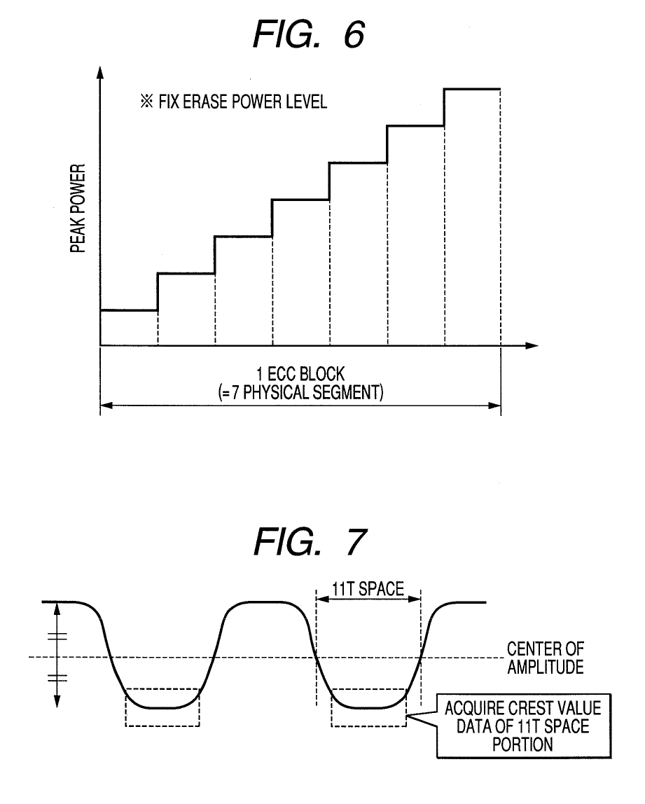

FIG. 6 is an exemplary diagram showing a method of changing the recording power level as an example. In an HD DVD, one ECC (Error Correction Code) block is configured by seven physical segments. Thus, in one ECC block, the erase power level is fixed and the peak power level is sequentially (7 steps) changed for each physical segment. Next, the same process is performed for recording on a different area of a different ECC block with a changed erase power level. As described above, combinations of the erase and peak power levels in a predetermined range are covered. The method of changing the recording power is an example, and accordingly, embodiments are not limited thereto.

Next, in step ST4, it is determined whether the number of times of overwriting operations has reached the number of times of evaluation overwriting operations. The number of times of overwriting operations increases from the 1st recording to the 1st overwriting operation, and then to the 2nd overwriting operation by once at a time, and it is determined whether the current overwriting is to be evaluated.

When it is determined that the number of times of overwriting operations has not reached the number of times of evaluation overwriting, the process proceeds back to step ST3 for repeating the overwriting operation for the same area.

On the other hand, when it is determined that the number of times of overwriting operations has reached the number of times of evaluation overwriting, the process proceeds to step ST5. In the example described above, when the number of overwriting reaches the 1st recording, 1st overwriting, 10th overwriting, or 100th overwriting, the process proceeds to step ST5.

In step ST5, data stored in the test recording area is reproduced, and the crest value of the 11T space area is extracted. FIG. 7 is an exemplary diagram showing an extraction range as an example. For example, the crest value of an area surrounded by a dotted line in the shape of a rectangle is extracted. Then, a standard deviation and an average value are calculated by using the extracted crest value data. For example, when a pattern in which an 11T mark and an 11T space are repeated is recorded, the sampling number of the 11T space area per one physical segment becomes about “66000” channel bits, whereby a sufficient sampling number for evaluation of the standard deviation or average value can be acquired.

In step ST6, it is determined whether the number of times of overwriting operations has reached the maximum number of overwriting, for example, 100th overwriting. When the maximum number of times of overwriting operations has not been reached, the process proceeds back to step ST3, and the process from step ST3 to step ST5 is repeated until the maximum number of times of overwriting operations is reached. When the maximum number of times of overwriting operations is reached, the process proceeds to the process of step ST7 and thereafter.

In this step, standard deviations and average values of the 11T space area for all the combinations of the peak and erase power levels for each evaluation overwriting operation are acquired. The process of step ST7 to step ST9 is for determining the optimal recording power level by using the acquired data.

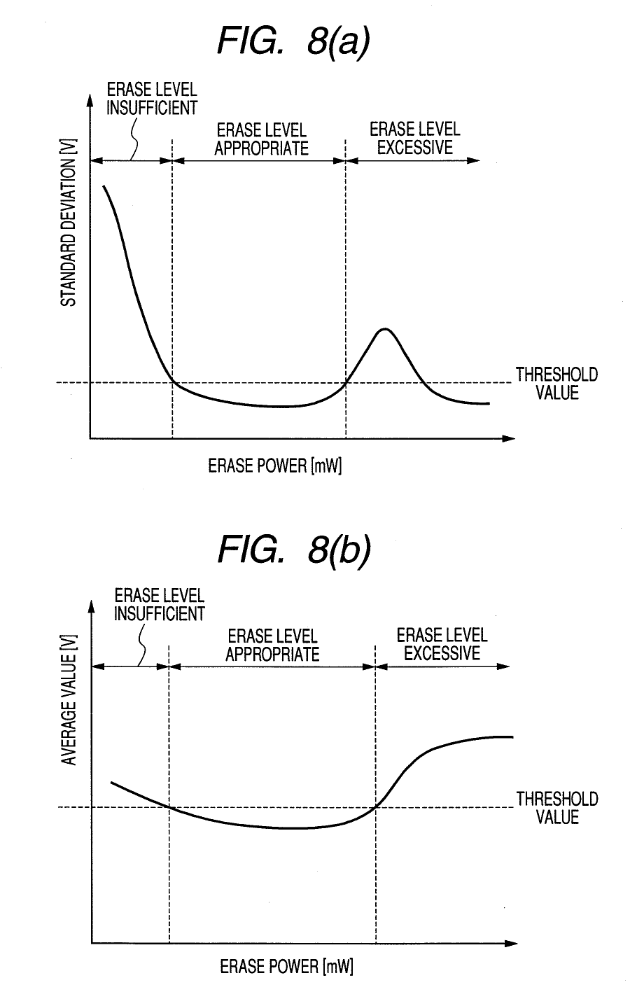

FIG. 8(a) is a diagram showing a relationship between an erase power level and a standard deviation of a crest value of the 11T space area for a specific number of times of evaluation overwriting operations and a specific peak power level. The horizontal axis of the diagram represents the erase power levels, and the vertical axis of the diagram represents the standard deviations.

Similarly, FIG. 8(b) is a diagram showing a relationship between an erase power level and an average value of a crest value of the 11T space area. The horizontal axis of the diagram represents the erase power levels, and the vertical axis of the diagram represents the average values.

The standard deviation shown in FIG. 8(a) is large when the erase power level is low, which corresponds to FIG. 4(b). When the erase power level increases to be in an appropriate range, the standard deviation becomes small, which corresponds to FIG. 4(a). When the erase power level increases further to exceed the appropriate range, the standard deviation becomes large, which corresponds to FIG. 4(c). When the erase power level increases still further, the standard deviation becomes small, which corresponds to FIG. 4(d).

As shown in FIG. 8(a), two ranges of the erase power levels, at which the standard deviation is equal to or smaller than a threshold value, including a center area and a right-side area exist. Thus, it may be inappropriate to determine an appropriate range of the erase power levels on the basis of the standard deviation only. Accordingly, in the embodiment, as shown in FIG. 8(b), an appropriate range at which the average value is equal to or less than a predetermined threshold value is acquired additionally, and a range common to the two appropriate ranges is determined to be a correct appropriate range.

Similarly, appropriate ranges for other peak power levels can be acquired. When this process is performed for all the peak power levels, combinations of an erase power level and a peak power level at which the standard deviation and average value of the crest values are equal to or less than predetermined threshold values are acquired. These combinations are acquired for each evaluation overwriting operation.

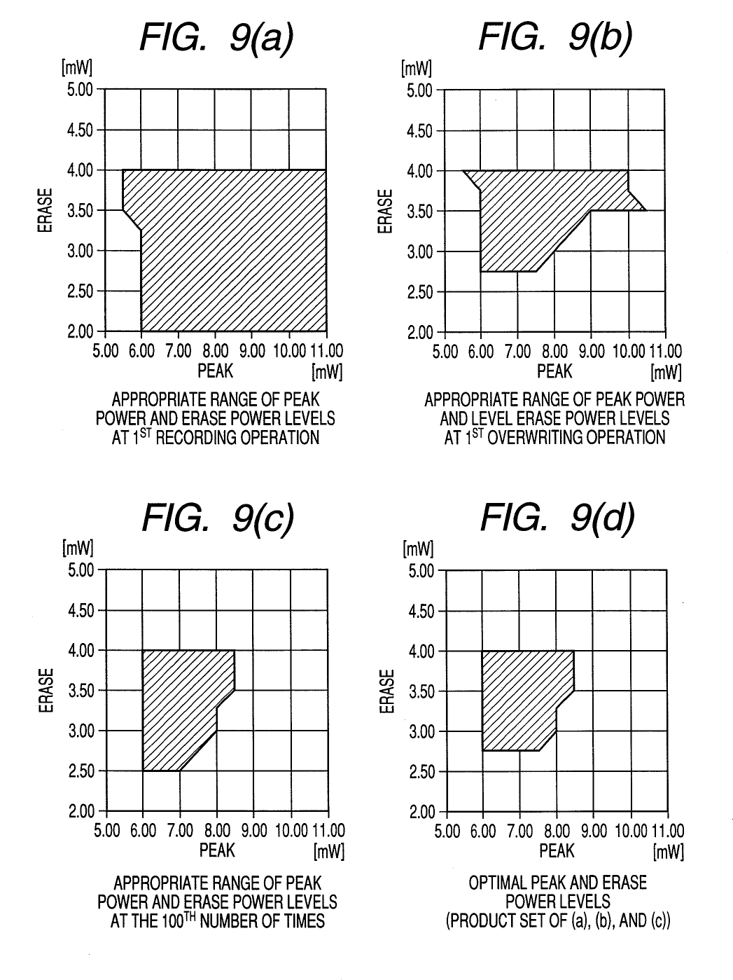

FIGS. 9(a), 9(b), and 9(c) show combinations of the erase and peak power levels at which the standard deviation and the average value are equal to or less than the predetermined threshold values, that is, appropriate ranges of the erase and the peak power levels when the number of times of evaluation overwriting operations is the 1st recording, the 1st overwriting, or the 100th overwriting.

When it is the 1st time recording, that is when an overwriting operation has not been performed before, as shown in FIG. 9(a), the appropriate range of the erase and peak power levels are relatively broad. However, after an overwriting operation is performed once, as shown in FIG. 9(b), the appropriate range of the erase and peak power levels are narrowed. As the number of times of overwriting operations increases to be 100th of overwriting operations, as shown in FIG. 9(c), the appropriate range shifts to a lowered peak power side.

As described above, since the appropriate range of the erase and peak power levels changes on the base of the number of times of the overwriting operations, a range (a product set of sets of appropriate ranges) common to appropriate ranges of the erase and peak power levels is acquired for determining the optimal recording power level (step ST8).

FIG. 9(d) shows the product set. Finally, an optimal peak power level and an optimal erase power are selected from this product set and the optimal peak and erase power levels are set as the optimal recording power level (step ST9).

In this case, the center position of the product set may be acquired and the erase and peak power levels may be set as the optimal recording power.

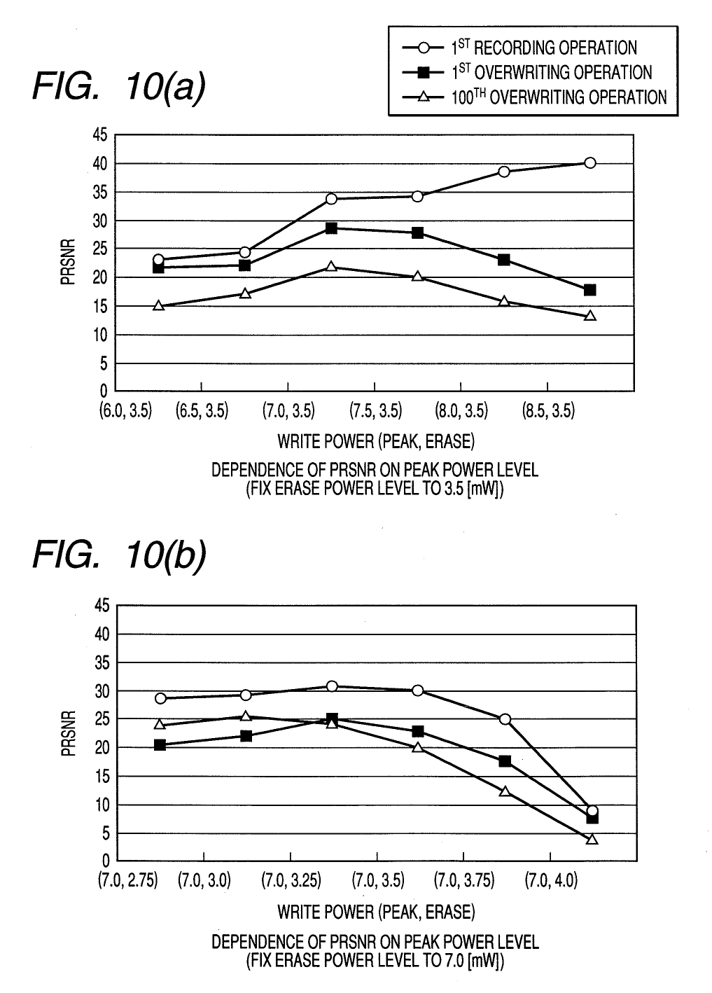

FIG. 10 is an exemplary diagram showing a relationship between the erase and peak power levels in the range of the product set shown in FIG. 9(d) and a PRSNR (Partial Response Signal to Noise Ratio). The PRSNR is one of composite evaluation indexes for an HD DVD or the like that uses a signal processing method of PRML (Partial Response Maximum Likelihood), and the PRSNR is equal to or greater than 15 in the specification thereof.

In particular, FIG. 10 is a diagram in which measured values of PRSNR corresponding to the peak power levels around 7.0 mW and the erase power levels around 3.5 mW which corresponds to the approximate center of the product set shown in FIG. 9(d) are plotted.

FIG. 10(a) is a graph representing PRSNRs at the 1st recording, 1st overwriting, and 100th overwriting when the erase power level is fixed to 3.5 mW and the peak power level changes. At the 1st recording, the PRSNR increases as the peak power level increases. In the 100th overwriting, the PRSNRs have an approximate symmetry with respect to a center position thereof.

FIG. 10(b) is a graph representing PRSNRs at the 1st recording, 1st overwriting, and 100th overwriting when the peak power level is fixed to 7.0 mW and the erase power level changes. As shown in FIG. 10(b), there is not a big difference of the trend of changes in the PRSNR characteristic between at the 1st recording and the 100th overwriting. The PRSNR characteristic at the 100th overwriting is asymmetrical with respect to the center position thereof, and an optimal point at the 100th overwriting is located in a position corresponding to an erase power level lower than that of the center position.

Accordingly, when a center position of the appropriate range of the erase and peak power levels which is represented as the product sum is to be acquired, the center position may be acquired with having a heavy weighting factor in the lower erase power-level side.

Furthermore, a combination of the erase and peak power levels, which has the lowest standard deviation, in the product set may be determined to be a set of the optimal erase and peak power levels.

Hereinafter, a recording power control method according to a second embodiment is exemplary described.

In the first embodiment, both the peak and erase power levels are sequentially changed for acquiring the optimal recording power level.

On the other hand, in a second embodiment of the invention, the optimal peak power level is determined in advance, and the optimal erase power level is acquired by sequentially changing only the erase power level with the peak power level being fixed to the optimal peak power level.

The optimal peak power is determined by performing an OPC (Optimum Power Control) that is commonly performed, for example, an OPC in which a β value or γ value of asymmetry is used as an evaluation index, by using a recommended recording parameter recorded in an optical disc or a recording strategy included in a table that is stored in the optical disc apparatus in advance.

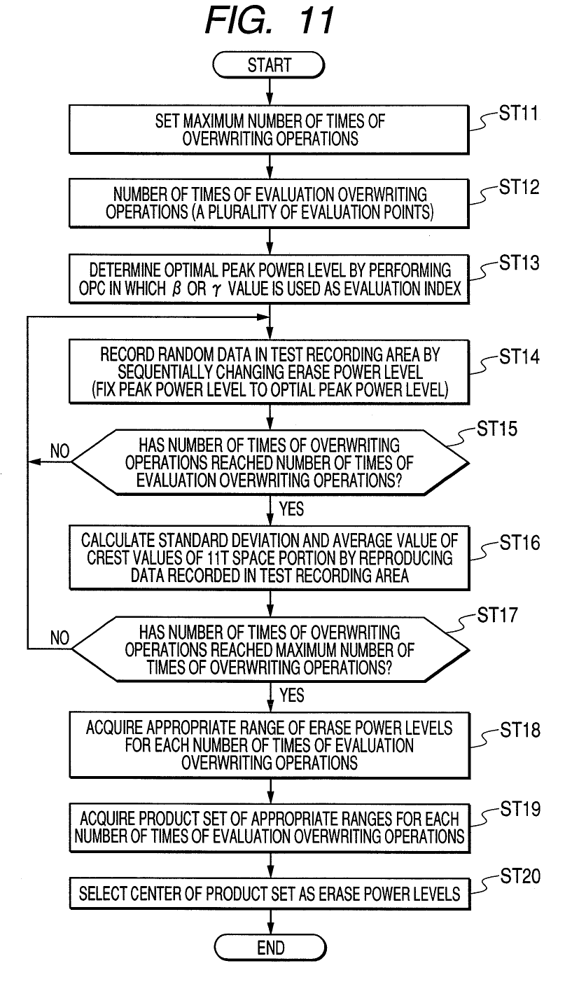

FIG. 11 is an exemplary flowchart showing a process of the recording power control method according to the second embodiment.

At first, as in the first embodiment, the maximum number of times of overwriting operations and the number of times of evaluation overwriting operations are set (steps ST11 and ST12).

Next, the optimal peak power is determined by performing an OPC (Optimum Power Control) that is commonly performed, for example, an OPC in which a β value or γ value of asymmetry is used as an evaluation index (step ST13).

Next, a recording pattern is recorded in a test recording area by sequentially changing the erase power level with the peak power level being fixed to the optimal peak power level determined in advance (step ST14).

When the number of times of overwriting operations reaches the number of times of evaluation overwriting operations, data recorded in the test recording area is reproduced so as to acquire a standard deviation and an average value of crest values of the 11T space area (steps ST15 and ST16).

When the number of times of the overwriting operations reaches the maximum number of times of overwriting operations, for example, 100 times (step ST17), the process proceeds to step ST16.

In step ST18, an appropriate range of the erase power levels for each evaluation overwriting operation is acquired. For acquiring appropriate range of the erase power levels for each evaluation overwriting operation, the same method as in the first embodiment is used.

Next, a product set of the appropriate ranges of erase power levels for each evaluation overwriting operation is acquired (step ST19). While a product set of two-dimensional sets of the peak and erase power levels is used in the first embodiment, a product set of one-dimensional (erase power level) sets is used in the second embodiment.

Finally, the center of the product set is determined to be the optimal erase power level (step ST20).

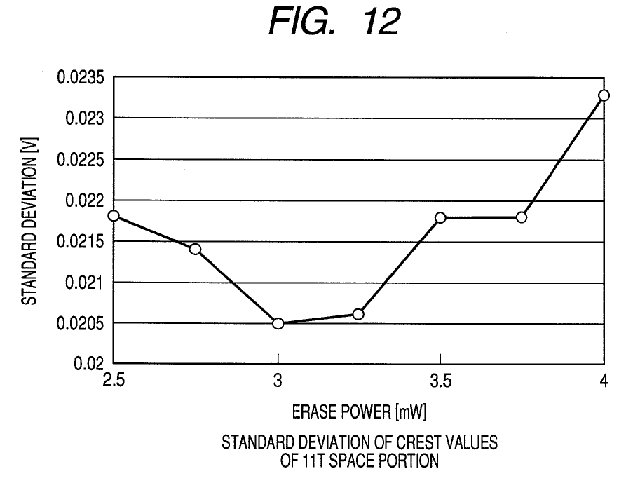

FIG. 12 is an exemplary diagram showing a result of measurement of the standard deviations of the 11T space area when only the erase power level is changed with the peak power level being fixed to the optimal peak power level, as an example. As is implied from the figure, an erase power level having the lowest standard deviation in the product set may be determined to be the optimal erase power.

As described above, according to an optical disc apparatus 1 and an optical disc recording and reproducing method, an optimal range of recording power to suppress variations of amplitude of readout signals can be determined for acquiring high-quality readout signals.

In an optical disc apparatus or an optical disc recording and reproduction method according to the above-described embodiments of the present invention, high-quality readout signals can be acquired by determining an optimal range of recording power levels to suppress variance of amplitude of the readout signals.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus comprising:
a recording unit configured to form a mark and a space on an optical disc with a laser beam having a predetermined recording power level and configured to record data on the optical disc;
a reproduction unit configured to reproduce the mark and the space formed on the optical disc;
a change amount calculating unit configured to calculate an amount of change in amplitude of a readout signal for the space reproduced by the reproduction unit; and
a recording power determining unit configured to determine an optimal recording power level of the laser beam so as to control the calculated amount of change in amplitude of the readout signal within a predetermined range.

2. The optical disc apparatus of claim 1, wherein the change amount calculating unit is configured to calculate the amount of change in amplitude of the readout signal at a plurality of recording power levels, and
wherein the recording power determining unit is configured to determine the optimal recording power level based on the amount of change in amplitude calculated at the plurality of recording power levels.

3. The optical disc apparatus of claim 2, wherein the plurality of recording power levels is configured from a combination of a plurality of erase power levels and a plurality of peak power levels.

4. The optical disc apparatus of claim 3, wherein the recording power determining unit is configured to select a combination at which the amount of change in amplitude is equal to or less than a predetermined threshold value among a combination of the plurality of erase power levels and the plurality of peak power levels, and
wherein the recording power determining unit is configured to determine the optimal recording power level using a combination of a first erase power level and a first peak power level which are the average values of the selected erase power and peak power levels respectively, when more than one combinations are selected.

5. The optical disc apparatus of claim 3, wherein the recording power determining unit is configured to select a combination of an erase power level and a peak power level among the predetermined combinations of the plurality of the erase power levels and the plurality of the peak power levels, so that the amount of change in amplitude is minimal, and is configured to determine the selected combination as the optimal recording power level.

6. The optical disc apparatus of claim 1,
wherein the recording unit is configured to overwrite until a predetermined maximum number of times of overwriting operations is reached and is configured to form the mark and space on the optical disc by sequentially configuring a plurality of erase power levels and a plurality of peak power levels for each overwriting,
wherein the change amount calculating unit is configured to calculate the amounts of change in amplitude of the readout signal for the space at each of the plurality of erase power levels and the plurality of peak power levels for each overwriting operation for evaluation when the overwriting operations for evaluation is performed a number of times of the overwriting operations for evaluation that are set within the range of the maximum number of times of the overwriting operations in advance,
wherein the recording power determining unit is configured to select a combination at which the amount of change in amplitude is equal to or smaller than a predetermined threshold value among a combination of the plurality of erase power levels and the plurality of peak power levels for each overwriting operation for evaluation, and
wherein the recording power determining unit is configured to select a combination common to the overwriting operations for evaluation from the selected combination and configured to determine the optimal power level using a combination of an average value among the selected erase power levels and an average value among the selected peak power levels if more than one combinations are selected.

7. The optical disc apparatus of claim 2,
wherein the recording power determining unit is configured to select an erase power level at which the amount of change in amplitude is equal to or less than a predetermined threshold value from an optimal peak power level which is predetermined and the plurality of the erase power levels, and
wherein the recording power determining unit is configured to determine an average value of the selected erase power levels or an erase power level at which the amount of change in amplitude is minimal as an erase power level when the selected erase power level is a plurality of the selected erase power levels.

8. An optical disc recording and reproduction method comprising:
recording data on an optical disc by forming a mark and a space on the optical disc with a laser beam having a predetermined recording power level;
reproducing the mark and the space formed on the optical disc;
calculating an amount of change in amplitude of a readout signal for the reproduced spaces; and
determining an optimal power level of the laser beam to control the calculated amount of change in amplitude within a predetermined range.

9. The optical disc recording and reproduction method of claim 8, comprising:
forming, when the recording power of the laser beam is determined, the mark and the space on the optical disc by sequentially setting a plurality of recording power levels when the data is recorded on the optical disc;
calculating the amount of change in amplitude of the readout signal for the spaces at a plurality of recording power levels when the amount of change in amplitude of the readout signal for the reproduced spaces is calculated;
determining the optimal recording power level on the basis of the calculated amount of change in amplitude; and
recording data with the determined recording power level after the optimal recording power level is determined.

10. The optical disc recording and reproduction method of claim 9, comprising:
setting the plurality of recording power levels computed from a combination of a plurality of erase power levels and a plurality of peak power levels.

11. The optical disc recording and reproduction method of claim 10, comprising:
selecting a combination at which the amount of change in amplitude is equal to or less than a predetermined threshold value among combinations of the plurality of erase power levels and the plurality of peak power levels, when the optimal recording power is determined for the recording power of the laser beam;
determining the optimal recording power level using a combination of an erase power level and a peak power level which are the average value of the selected erase power and peak power levels respectively, if the selected combination is in plural.

12. The optical disc recording and reproduction method of claim 10, comprising:
selecting a combination, when the recording power is determined, at which the amount of change in amplitude is minimal, among the set combinations of the plurality of the erase power levels and the plurality of the peak power levels; and
determining the selected combination as the optimal recording power level.

13. The optical disc recording and reproduction method of claim 8, comprising:
overwriting until a predetermined maximum number of times of overwriting operations is reached;
forming, when the optimal recording power is determined, the marks and spaces on the optical disc by sequentially setting a plurality of erase power levels and a plurality of peak power levels for each overwriting operation;
calculating the amount of change in amplitude of the readout signal for the space at each of the plurality of erase power levels and the plurality of peak power levels when the overwriting operations are performed a number of times of the overwriting operations for evaluation that are set within the range of the maximum number of times of the overwriting operations in advance in calculating the amount of change in amplitude of the readout signal for the reproduced spaces;
selecting a combination at which the amount of change in amplitude is equal to or smaller than a predetermined threshold value among combinations of the plurality of erase power levels and the plurality of peak power levels for each overwriting operation for evaluation;
selecting a combination common to the overwriting operation for evaluation among the selected combination; and
determining an average value among the selected erase power levels and an average value among the selected peak power levels to be the optimal power levels if a number of the selected combinations is in plural in determining the power level of the laser beam to control the calculated amount of change in amplitude within a predetermined range.
